(19) United States
(12) Patent Application Publication
(10) Pub. No.: US 2013/0038509 A1
(43) Pub. Date: Feb. 14, 2013

(54) METHOD FOR COORDINATING TABLET COMPUTER WITH AT LEAST ONE OTHER TABLET COMPUTER TO PLAY AUDIO/VIDEO FILE AND PLAYING SYSTEM USING THE SAME

(71) Applicant: Chun Jiang, Shanghai City (CN)

(72) Inventor: Chun Jiang, Shanghai City (CN)

(73) Assignees: INVENTEC APPLIANCES (PUDONG) CORPORATION, Shanghai (CN); INVENTEC APPLIANCES (SHANGHAI) CO.,LTD., Shanghai City (CN); INVENTEC APPLIANCES CORP., New Taipei City (TW)

(21) Appl. No.: 13/570,246

(22) Filed: Aug. 9, 2012

(30) Foreign Application Priority Data
Aug. 9, 2011 (CN) 201110226598.2

(51) Int. Cl. G09G 5/00

(52) U.S. Cl. 345/1.3

(57) ABSTRACT

A method for coordinating a tablet computer with at least one other tablet computer to play an audio/video file and a playing system using the same are proposed. The method includes: establishing a wireless connection between a tablet computer acting as a master computer and at least one other tablet computer acting as a slave computer; the master computer generating an arrangement signal at least according to an arrangement of positions of the tablet computers; the master computer generating at least two divisional signals according to the arrangement signal and an audio/video file, each corresponding to a portion of video frame in the audio/video file; the master computer transmitting the divisional signals to the slave computer to enable the master computer and the slave computer to respectively display the portion of video frame corresponding to the divisional signals; and the master computer transmitting a synchronizing signal to the slave computer.

### CROSS-REFERENCE TO RELATED APPLICATION

This application claims the priority benefit of China application serial no. 201110226598.2, filed on Aug. 9, 2011. The entirety of the above-mentioned patent application is hereby incorporated by reference herein and made a part of this specification.

### BACKGROUND OF THE INVENTION

1. Field of the Invention

The invention relates to a method for coordinating a tablet computer with at least one other tablet computer to play an audio/video file and a playing system using the same method. The method for coordinating a tablet computer with at least one other tablet computer to play an audio/video file may establish a wireless connection between a tablet computer and at least one other tablet computer, generate at least one arrangement signal, respectively generate at least two divisional signals corresponding to a portion of video frame in an audio/video file through each of the at least one arrangement signal and the audio/video file, and then each of the tablet computers correctly play the portion of the video frame corresponding to a respective one of the at least one divisional signals. Thereby, users of the tablet computers experience greater and better audio and video playing effects together through arranging their own respective tablet computers.

2. Description of Related Art

In recent years, due to advancement of microcomputer technology and vigorous development of electronic industry, various kinds of mobile devices are developed and emerge in market, and the mobile devices are, for example, personal digital assistants (PDA), smart phones, tablet personal computers (PC) and so like. The tablet PC becomes one of the most popular products due to the fact that the tablet PC has both functionality of conventional notebook PC and convenience of smart phones, and the users can conveniently carry the tablet PC to any place and use the tablet PC at any time. Although the tablet PC has advantages of being light, thin, short and compact size, when a user wants to watch an audio/video file (e.g., a movie, one of television series or a video clip), bigger sizes of video cannot be generated due to the display of the tablet PC being limited to the size thereof and the tablet PC being light, thin, short and compact size. Thus, playing effects of the tablet PC cannot reach a three-dimensional level and delicateness similar to that of a television set, and such drawback of the tablet PC seems to be an obstacle which may not be easily overcome when the tablet PC vendors design all mobile electronic devices.

Regarding the aforementioned drawbacks, there are some vendors making improvements on general mobile electronic devices. FIG. 1 illustrates a portable electronic device 1 which has dual screens, and the portable electronic device 1 includes a display module 11 and a host module 12. Referring to FIG. 1, the display module 11 includes two displays 110, and the two displays 110 are connected with each other and integrated to be one display unit. The two displays 110 are respectively allocated with connection cables 112. There are allocated two connection slots 120 on the host module 12 in positions corresponding to the connection cables 112. Each connection cable 112 has a shape matched to that of each connection cable 112 such that each connection cable 112 may be plug into the each connection cable 112, and each display 110 may be electrically connected to the host module 12. Thereby, the portable electronic device 1 may display a greater playing frame on the display module 11, and the greater playing frame improves displaying effects of the portable electronic device 1 when playing an audio/video file. Additionally, when the user no longer uses the portable electronic device 1, the user only needs to turn each display 110 so as to close the display module 11 to be in a matched size to that of the host module 12, and the resultant size of the portable electronic device 1 is convenient for the user to carry. Though the portable electronic device 1 may provide a greater display frame, there may be various problems when manufacturing and selling the portable electronic device 1, and the problems are described below.

(1) the cost of the portable electronic device 1 is too expensive: although the display module 11 of the portable electronic device 1 is composed of two displays 110, which enables the portable electronic device 1 display a greater display frame; other the other hand, the display module 11 having a greater volume requires more manufacturing cost, thereby impacting upon competitiveness of selling the portable electronic device 1.

(2) the weight of the portable electronic device 1 is too heavy: although the display module 11 of the portable electronic device 1 can be closed to matched size to that of the host module 12, and the resultant size is convenient for the user to carry the portable electronic device 1; on the other hand, the overall weight of the portable electronic device 1 is much greater than that of the general mobile electronic device since the portable electronic device 1 is composed of two displays 110. Also, frequently watching audio/video files is not a common habit for every user. Thus, when the portable electronic device 1 has greater weight and higher cost, the convenience and popularity of the portable electronic device 1 cannot be easily highlighted when the vendor designing the portable electronic device 1. Therefore, the design of the portable electronic device 1 is not a perfect solution.

Based on the aforementioned descriptions, though every kind of mobile electronic device has drawback of poorer playing effects, main purpose of every kind of mobile electronic device is to be used and carried by users. If vendors of mobile electronic devices can make improvements on hardware structure, the improved effect will be limited by original structure of the mobile electronic device. Therefore, it is an important issue on how to design a method or a playing system, which may enable multiple users to arrange their own respective tablet PCs to form a bigger display frame, and the resultant bigger display frame may not only reach a playing quality of greater vision effect shared by the users, but also may not impact upon the vendor's manufacturing cost of the tablet PCs and may not result in inconvenience of carrying the mobile electronic device by the users.

### SUMMARY OF THE INVENTION

The invention is directed to a method and a playing system for coordinating a tablet computer with at least one other tablet computer to play an audio/video file.

In view of an object of the invention, the invention provides a method for coordinating a tablet computer with at least one other tablet computer to play an audio/video file. The method includes the following steps: establishing a wireless connection between a tablet computer acting as a master computer and at least one other tablet computer acting as a slave computer; the master computer generating at least one arrangement signal according to the total number of the tablet computers that are connected and an arrangement of positions of the tablet computers, wherein the arrangement signal corresponds to an arranged position of the slave computer relative to the master computer; the master computer generating at least two divisional signals according to the arrangement signal and an audio/video file, each corresponding to a portion of video frame in the audio/video file; the master computer transmitting at least one of the divisional signals to the slave computer to enable the master computer and the slave computer to respectively display the portion of video frame corresponding to a respective one of the at least two divisional signals; and the master computer transmitting a synchronizing signal to the slave computer to synchronize the displaying of the portion of video frame respectively by the master computer and the slave computer.

In an embodiment, the method further includes a step of the master computer transmitting a stopping instruction to the slave computer to stop displaying the portion of video frame at the master computer and the slave computer.

In an embodiment, each of the tablet computers has an identifier establishing the identity of said each tablet computer for the step of establishing the wireless connection between the tablet computers.

In an embodiment, the method further includes a step of the master computer receiving and then transmitting a command signal to the slave computer to enable each of the tablet computers to perform a corresponding action.

In an embodiment, upon the step of the master computer generating the arrangement signal, the method further includes: if the master computer or the slave computer is connected to an audio equipment, the master computer extracting an audio signal from the audio/video file, and transmitting the audio signal to the audio equipment for playing sounds of the video file by the audio equipment.

In an embodiment, upon the step of the master computer generating the arrangement signal, the method further includes: if the master computer or the slave computer is not connected to an audio equipment, the master computer generating a playing signal according to the arrangement signal and the audio/video file, and providing the playing signal for the master computer or the slave computer to play corresponding sounds of the audio/video file according to the playing signal.

In view of an object of the invention, the invention provides a playing system for coordinating a tablet computer with at least one other tablet computer to play an audio/video file. The playing system includes a tablet computer and at least one other tablet computer. Each of the tablet computer and the other tablet computer has a display, a wireless transmission unit, and a control unit. When the tablet computer and the other tablet computer are arranged with each other and connected by a wireless connection through their respective wireless transmission units, the tablet computer is configured to act as a master computer and the other tablet computer is configured to act as a slave computer. The control unit of the master computer is configured to generate at least one arrangement signal according to the total number of the tablet computers that are connected and an arrangement of positions of the master computer and the slave computer, wherein the arrangement signal corresponds to an arranged position of the slave computer relative to the master computer. The control unit of the master computer is also configured to generate at least two divisional signals, according to the arrangement signal and an audio/video file, each corresponding to a portion of video frame in the audio/video file. The control unit of the master computer is also configured to transmit at least one of the divisional signals to the slave computer to enable the master computer and the slave computer to respectively display on their displays the portion of video frame corresponding to a respective one of the at least two divisional signals. Further, the control unit of the master computer is also configured to transmit a synchronizing signal to the slave computer to synchronize the displaying of the portion of video frame respectively by the master computer and the slave computer. The control unit of the slave computer is configured for displaying the portion of video frame corresponding to the transmitted at least one of the divisional signals and according to the received synchronizing signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional portable electronic device having dual displays.

FIG. 2 is a schematic diagram of a playing system according to an embodiment of the invention.

FIG. 3 a functional block diagram of a tablet computer according to an embodiment of the invention.

FIG. 4A and FIG. 4B are flowcharts of operations of a master tablet computer according to a preferred embodiment of the invention.

FIG. 5A and FIG. 5B are flowcharts of operations of a slave tablet computer according to a preferred embodiment of the invention.

FIG. 6A is a schematic diagram of playing a video file by a single tablet computer.

FIG. 6B is a schematic diagram of playing a video file by two tablet computers according to an embodiment of the invention.

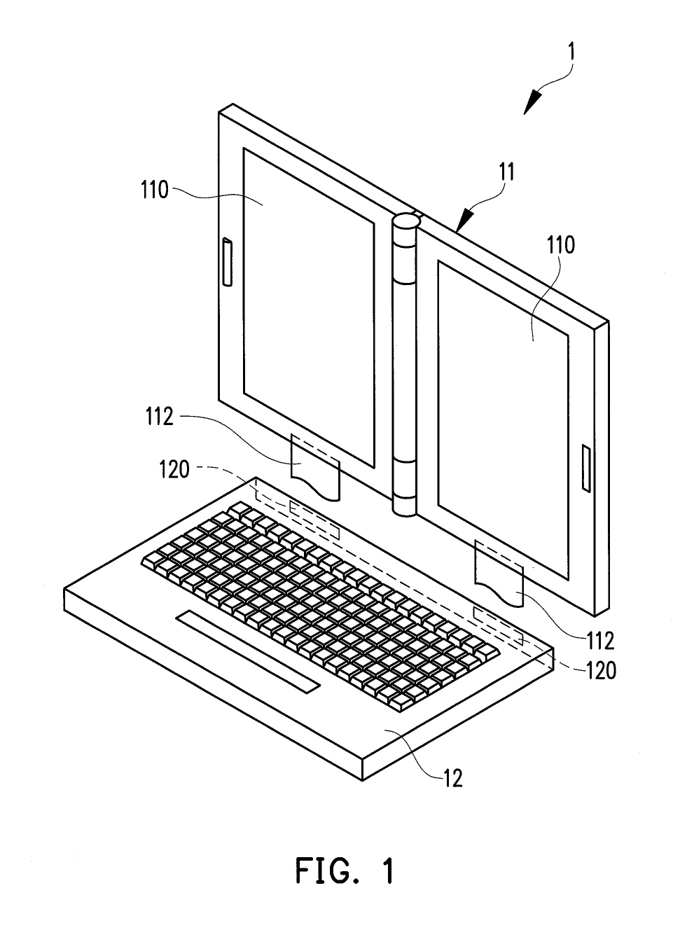

### DETAILED DESCRIPTION OF DISCLOSED EMBODIMENTS

In view of aforementioned problems that displaying effects of tablet computers in market are limited by sizes of tablet computers when playing audio/video files, based on practical experience, the inventor of the present invention holds that, under the circumstance of tablet computers becoming more popular, if a plurality of tablet computers can be integrated for playing an audio/video file, problems of playing effects of the tablet computers and inconvenience of carrying the tablet computers may be resolved effectively. Thus, after various experiments and tests performed by the inventor, a method for coordinating a tablet computer with at least one other tablet computer to play an audio/video file and a playing system using the same method are provided in the present disclosure. It is expected that multiple users may arrange their own respective tablet computers to form a greater display frame, so as to create better playing effects, and enhance entertainment level of users when watching the audio/video file.

One embodiment of the invention is a playing system for coordinating a tablet computer with at least one other tablet computer to play an audio/video file. The playing system includes a tablet computer and at least one other tablet computer. Each of the tablet computer and the other tablet computer has a display, a wireless transmission unit, a control unit, a storage unit and an audio equipment, where the control unit can be electrically connected with other components. The tablet computer and the other tablet computer may be arranged with each other and connected by a wireless connection through their respective wireless transmission units, and the tablet computer can be configured to act as a master computer and the other tablet computer can be configured to act as a slave computer.

Another embodiment of the invention is a method for coordinating a tablet computer with at least one other tablet computer to play an audio/video file. The method enables the tablet computer to perform following steps: establishing at least one wireless connection between the tablet computer acting as a master computer and at least one other tablet computer acting as a slave computer through the wireless transmission unit of the tablet computer; calculating the number of the tablet computers (i.e., the total number of the master computer and the slave computer) and then generating at least one arrangement signal according to the total number of the tablet computers that are connected and an arrangement of positions of the tablet computers, where the at least one arrangement signal corresponds to a position (for example, a slave computer B is located to a right bottom position of a master computer A) of the slave computer relative to the master computer; generating at least two divisional signals according to the at least one arrangement signal and an audio/video file, where each of the at least two divisional signals corresponds to a portion of video frame in the audio/video file; transmitting, through the wireless transmission unit, at least one of the divisional signals to the slave computer to enable the master computer and the slave computer to respectively display the portion of video frame corresponding to a respective one of the at least two divisional signals; transmitting, through the wireless transmission unit, a synchronizing signal to the slave computer to synchronize the displaying of the portion of video frame respectively by the master computer and the slave computer (for example, each of the portions of the video frame are synchronized to the same playing time); and the master computer finally transmitting a stopping instruction to the slave computer to stop displaying the portion of video frame at the master computer and the slave computer, and release wireless connection relationships of the tablet computers. Thereby, through the proposed method, users may clearly watch the audio/video file through the arrangement of positions of the tablet computers, so as to achieve better visual effects and sensational enjoyments.

According to yet another embodiment of the invention, each of the tablet computers has an identifier configured to establish the identity of said each tablet computer for establishing the wireless connection between the tablet computers, and the control unit of the master computer may transmit at least one of the divisional signals to the slave computer according to the identifier.

According to further another embodiment of the invention, upon the control unit of the master computer generating the arrangement signal, the master computer may further detect whether the master computer or the slave computer is connected to an audio equipment. If it is determined that the master computer or the slave computer is connected to an audio equipment, the control unit of the master computer may extract an audio signal form the audio/video file; otherwise, the control unit of the master computer may generate a playing signal according to the arrangement signal and the divisional signals, and then transmit the playing signal to the audio equipment connected to the slave computer through the wireless transmission unit, thereby enabling the audio equipment play corresponding sounds of the audio/video file according to the playing signal.

According to yet another embodiment of the invention, during the process of the master computer and the slave computer respectively displaying the portion of video frame of the audio/video file, if the control unit of the master computer receives a command signal (for example, pause, accelerated playing and so like), the master computer then transmits the command signal through the wireless transmission unit to the slave computer to enable each of the tablet computers to perform a corresponding action.

For long term research and development process of related industry of tablet computers, the inventor discovers that though the tablet computer has advantages such as conveniences in carrying and operating the tablet computer respectively, visual effects of the tablet computers playing the audio/video file is quite limited due to size of the tablet computer. Although many vendors make improvements on hardware structure of the tablet computers and expect such change on hardware structure may improve playing effects of the tablet computers, there are more drawbacks than benefits gained through such improvements, and thus requirement of consumers can still not be met. As the tablet computers become more popular, more attentions are paid on problems of playing effects. During the research, development and testing process, the inventor discovers that playing effects of the tablet computer is most associated with size of display of the tablet computer. Since people often need a larger playing frame to improve fun atmosphere when many people are having fun, the inventor propose a method for coordinating a tablet computer with at least one other tablet computer to play an audio/video file and a playing system using the same method in the present disclosure, and expects to integrate a plurality of tablet computers to display an audio/video file through software improvements.

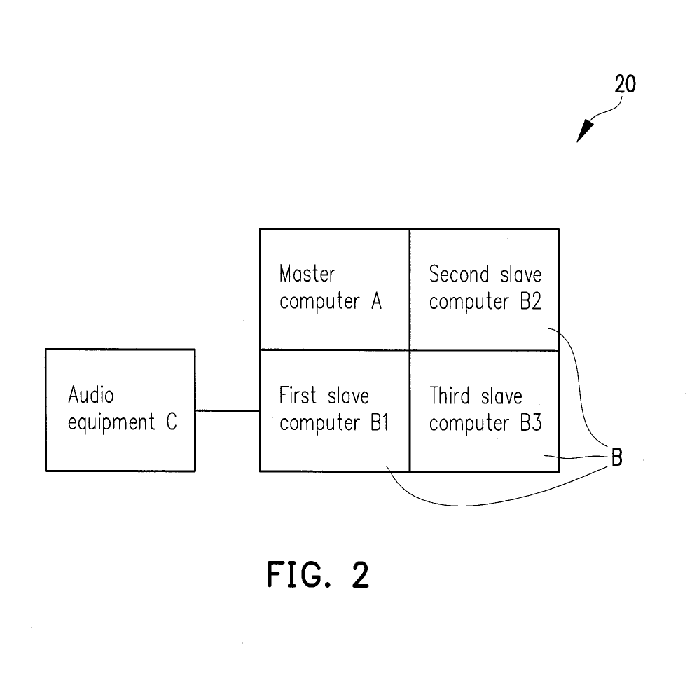

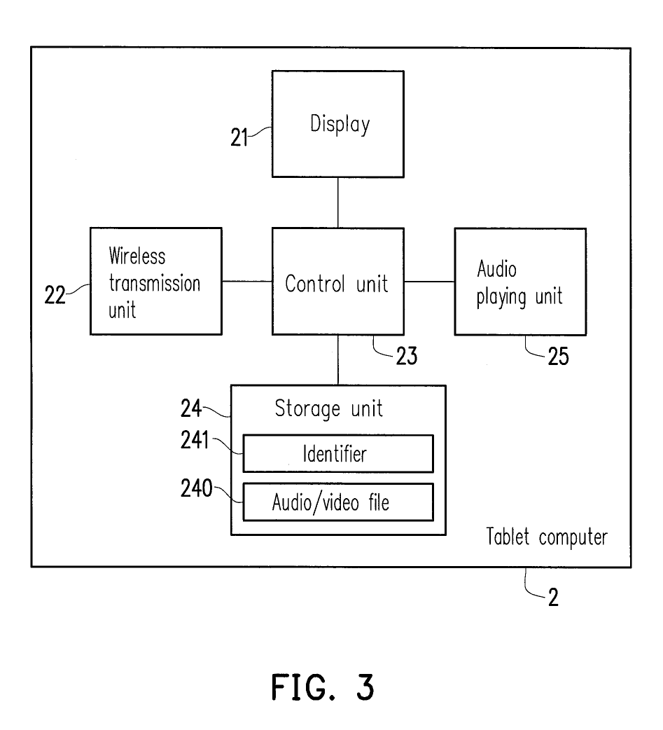

FIG. 2 illustrates a first preferred embodiment of a playing system 20. Referring to FIG. 2, the playing system 20 includes a tablet computer and at least one other tablet computer. The tablet computer can be configured to act as a master computer A, and the at least one other tablet computer can be configured to act as a slave computer B. FIG. 3 is a functional block diagram of a tablet computer 2 according to an embodiment of the invention. Referring to FIG. 3, each tablet computer 2 may include a display 21, a wireless transmission unit 22, a control unit 23, a storage unit 24 and an audio playing unit 25, where the control unit 23 can be electrically connected with other components in the tablet computer 2. The storage unit 24 of the tablet computer 2 can be configured to store an audio/video file 240 and an identifier 241. The wireless transmission unit 22 of the tablet computer 2 can be configured to establish a wireless connection with at least one other tablet computer 2 through the identifier 241 and wireless transmission (e.g., WIFI transmission, Bluetooth transmission or so like).

Referring to FIG. 2 and FIG. 3 again, upon the tablet computer 2 establishing the wireless connection with at least one other tablet computer 2 through its wireless transmission unit 22, the tablet computer 2 can assign one of the tablet computers 2 to act as the master computer A, and then assign other of the tablet computers 2 to act as the slave computer B (for example, the assignment may be configured manually by a user or through automatic determination of the control unit 23), and each of the slave computer B may be classified as a first slave computer B1, a second slave computer B2 and a third slave computer B3 according to their different identifiers. It is noted that in the first preferred embodiment of the invention, the storage unit 24 of each tablet computer 2 is configured to store the same audio/video file 240. Also, in other embodiments of the invention, the audio/video file 240 may also be only stored in the storage unit 24 of the master computer A, or stored in at least one of the slave computer B, and then the audio/video file 240 may be transmitted to the master computer A or other slave computer B through the wireless transmission unit 22 of each tablet computer 2.

Moreover, upon the wireless connections of the tablet computers 2 being established, the control unit 23 of the master computer A may be configured to calculate the total number of the tablet computers 2 (i.e., the total number of the master computer A and the slave computer B) that are connected, and then generate at least one arrangement signal according to the arrangement of positions (for example, the arrangement of positions may be manually input by the user, or a detection unit is added to the tablet computer 2 for detecting the arrangement of positions of the slave computer B) of the tablet computers 2, where each of the arrangement signal corresponds to a position of the slave computer B relative to the master computer A (for example, the first slave computer B1 is located to the bottom of the master computer A, the second slave computer B2 is located to the right side of the master computer A). Next, the master computer A may be configured to detect whether the master computer A or the slave computer B is connected to an external audio equipment C. If it is determined that the master computer A or the slave computer B is connected to an external audio equipment C, the master computer A may be configured to extract an audio signal according to the audio/video file 240; otherwise, the master computer A may be configured to generate a playing signal according to the audio/video file 240 and the arrangement signal, and provide the playing signal for the master computer A or the slave computer B to play corresponding sounds (for example, the master computer A and the first slave computer B1 may play sounds of a left sound channel in the audio/video file 240; the second slave computer B2 and the third slave computer B3 may play sounds of a right sound channel in the audio/video file 240) of the audio/video file at its audio playing device 25 according to the playing signal.

Further, upon the master computer A generating the playing signal or extracting the audio signal, the control unit 23 of the master computer A may be configured to generate at least two divisional signals according to the audio/video file 240 and the arrangement signal, where each of the at least two divisional signals corresponds to a portion of video frame (for example, a video frame at the right top corner of the audio/video file 240, or a video frame on the left half portion of the audio/video file 240) in the audio/video file. Then, the master computer A may be configured to transmit at least one of the at least two divisional signals to the slave computer B according to the identifier 241 of the slave computer B to enable the master computer A and the slave computer B to respectively display the portion of video frame corresponding to a respective one of the at least two divisional signals, and the portion of the video frame are arranged in a way such that a complete video frame of the audio/video file 240 is formed.

Additionally, upon the master computer A transmitting at least one of the at least two divisional signals to the slave computer B, the master computer A may be configured to transmit the audio signal to the audio equipment C, or transmit the playing signal to the corresponding slave computer B to enable the audio playing unit 25 of the slave computer B or the audio equipment C to play sound of the audio/video file 240. The control unit 23 of the master computer A may be configured to generate a synchronizing signal and transmit the synchronizing signal to the slave computer B such that the master computer A and the slave computer B (for simplicity and fluency of following descriptions, “the master computer A and the slave computer B” may be called as “the tablet computers”) are enabled to start playing the audio/video file 240, and it is ensured that the portion of the video frame played by the tablet computer 2 corresponds to sound played by the tablet computer 2. Thus, the synchronizing signal avoids problems of latency between the portions of the video frame and the playing signals among the tablet computer 2, and also avoids problems of the portions of video frame not corresponding to each other.

Referring to FIG. 2 and FIG. 3 again, during a process of the slave computer B receiving the synchronizing signal and starting to play the audio/video file 240, if the user inputs a command signal on the master computer A, then the master computer A may transmit the command signal to the slave computer B to enable the master computer A and the slave computer B to perform corresponding action(s), and maintain the action (for example, pause, accelerated playing or decelerated playing). When the user cancels the command signal, the master computer A will stop transmitting the command signal to the slave computer B, and continue transmitting the synchronizing signal to the slave computer to enable the tablet computers 2 resume playing the audio/video file 240 at a normal speed. Also, if the user enters a command signal at the slave computer B, the slave computer B may firstly transmit the command signal to the master computer A. Upon receiving the command signal, the master computer A may be configured to consistently transmit the command signal to all the slave computers B to enable the tablet computer 2 to perform corresponding action(s) simultaneously. Further, when the master computer A detects that the audio/video file 240 is played completely, the master computer A may be configured to transmit a stopping instruction to the slave computer B or to the audio equipment C so as to stop displaying the portion of video frame at the master computer A and slave computer B, also stop playing sounds at the audio equipment C, and then release wireless connections between the tablet computers 2.

In order to clearly illustrate the method for coordinating a tablet computer with at least one other tablet computer to play an audio/video file of the invention, an example of the tablet computer being configured as the master computer is taken to describe processing operations of the control unit thereof with reference to FIGS. 2, 3, and 4 below.

Step (401): the tablet computer establishes a wireless connection with at least one other tablet computer 2 through its wireless transmission unit 22, the tablet computer configures itself to act as the master computer A, configures the at least one other tablet computer 2 to act as the slave computer B, and then step (402) is executed after the step (401);

Step (402): the master computer A determines and calculates the number of the tablet computers 2, and generates at least one arrangement signal according to the arrangement of positions of the slave computer B, where each of the at least one arrangement signal corresponds to a position of the slave computer relative to the master computer, and then step (403) is executed after the step (S402);

Step (403): the master computer A detects whether the master computer A or the slave computer B is connected to the audio equipment C, where if it is determined yes, then step (404) is executed after the step (403); otherwise, step (405) is executed after the step (403).

Step (404): If the master computer A detects that the master computer A or the slave computer B is connected to an audio equipment C, then the master computer A extracts the audio signal from the audio/video file 240, and then step (406) is executed after the step (404);

Step (405): If the master computer A does not detect that the master computer A or the slave computer B is connected to an audio equipment C, then the master computer A generates the playing signals according to the arrangement signal the audio/video file 240, and then step (406) is executed after the step (405);

Step (406): the master computer A generates the at least two divisional signals, where each of the at least two divisional signals corresponds to a portion of video frame in the audio/video file, the master computer A respectively transmits the at least two divisional signals through the wireless transmission unit 22 to the corresponding slave computer B, and then step (407) is executed after the step (406);

Step (407): the master computer A respectively transmits the playing signal through the wireless transmission unit 22 to the corresponding slave computer B, or transmits the audio signal to the audio equipment C, and then step (408) is executed after the step (407);

Step (408): the master computer A respectively transmits a synchronizing signal through the wireless transmission unit 22 to the corresponding slave computer B, and then step (409) is executed after the step (408);

Step (409): the master computer A determines whether the audio/video file 240 is played completely, where if it is determined yes, then step (412) is executed after the step (409); otherwise, step (410) is executed after the step (409);

Step (410): the master computer A detects whether a command signal is received, where if it is determined yes, step (411) is executed after the step (410); otherwise, the step (408) is executed after the step (410);

Step (411): the master computer A transmits the command signal through the wireless transmission unit 22 to the slave computer B to perform the corresponding action, and then step (410) is executed after the step (408); and

Step (412): the master computer A transmits the stopping instruction through the wireless transmission unit 22 to the corresponding slave computer B to stop playing the audio/video file 240, and then releases the wireless connection between the master computer A and the slave computer B.

Base upon the aforementioned descriptions, through the method and the playing system 20 for coordinating a tablet computer with at least one other tablet computer to play an audio/video file 20, the users can arrange the tablet computers 2 to from a larger display 21, so as to enhance sensational effects when watching the audio/video file 20, and the tablet computers 2 can accurately play the audio/video file in a synchronized manner, thereby ensuring playing quality of the tablet computers 2. Additionally, since the proposed method of the invention does not need to make any change to the hardware structure of the tablet computers 2, the vendors may conveniently and popularly apply the proposed method to the tablet computers 2 of any specification by software implementations. Also, since any user can input command signal in any one of the tablet computers 2, when multiple user are watching the audio/video file 240 simultaneously, any one of the users may conveniently input the command signal in any one of the tablet computers 2 to conveniently control the tablet computers 2.

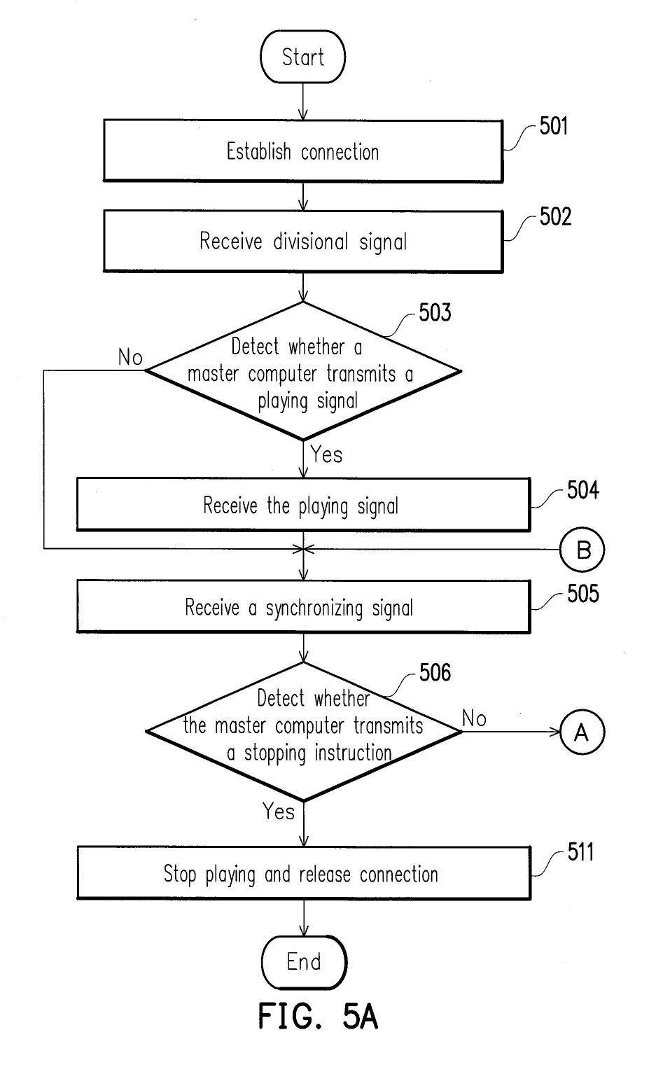

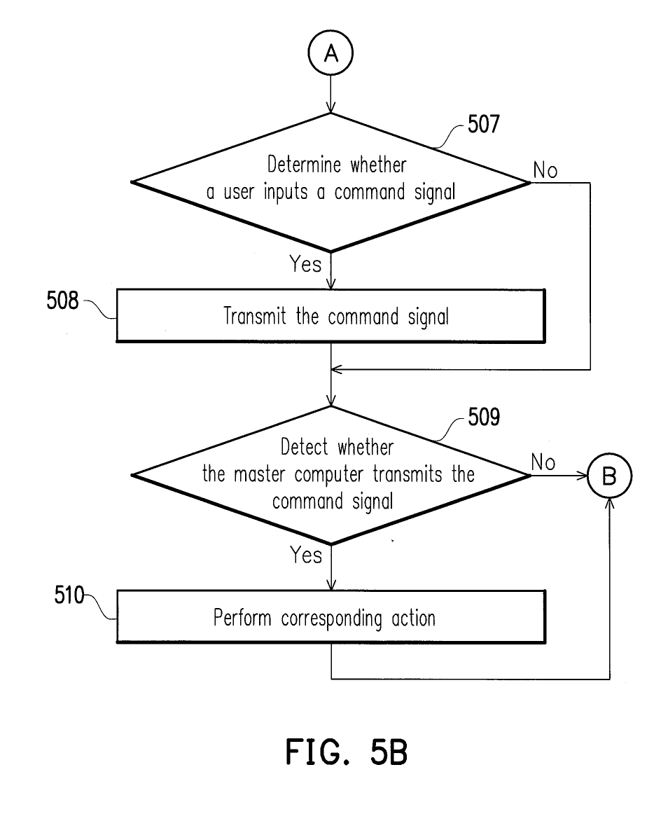

Further, in order to specifically disclose the proposed method for coordinating a tablet computer with at least one other tablet computer to play an audio/video file of the invention, an example of the tablet computer being configured as the slave computer is taken to describe processing operations of the control unit thereof with reference to FIG. 2, FIG. 3 and FIG. 5 below.

Step (501): the slave computer, through its own wireless transmission unit 22, establishes a wireless connection with the wireless transmission unit 22 of the master computer A, and then step (502) is executed after the step (501);

Step (502): the slave computer receives the division signal from the master computer A, and then the step (503) is executed after the step (502);

Step (503): the slave computer detects whether the master computer A transmits the playing signal, where if it is determined that the master computer A transmits the playing signal, step (504) is executed after the step (503); otherwise, step (505) is executed after the step (503);

Step (504): the slave computer receives the playing signal through the wireless transmission unit 22, and then the step (505) is executed after the step (504);

Step (505): the slave computer receives the synchronizing signal from the master computer A through the wireless transmission unit 22, and then step (506) is executed after the step (505);

Step (506): the slave computer detects whether the master computer A transmits the stopping instruction, where if it is determined that the master computer A transmits the stopping instruction, step (511) is executed after the step (506); otherwise, step (507) is executed after the step (506);

Step (507): the slave computer determines whether the user inputs the command signal, where if it is determined that the user inputs the command signal, step (508) is executed after the step (507); otherwise, step (509) is executed after the step (507);

Step (508): the slave computer transmits the command signal to the master computer A through the wireless transmission unit 22, and then the step (509) is executed after the step (508);

Step (509): the slave computer detects whether the master computer A transmits the command signal, where if it is determined that the master computer A transmits the command signal, step (510) is executed after the step (509); otherwise, the step (505) is executed after the step (509).

Step (510): the slave computer performs the corresponding action, and then the step (507) is executed after the step (510); and

Step (511): the slave computer stops playing the audio/video file 240, and releases the wireless connection with the master computer A.

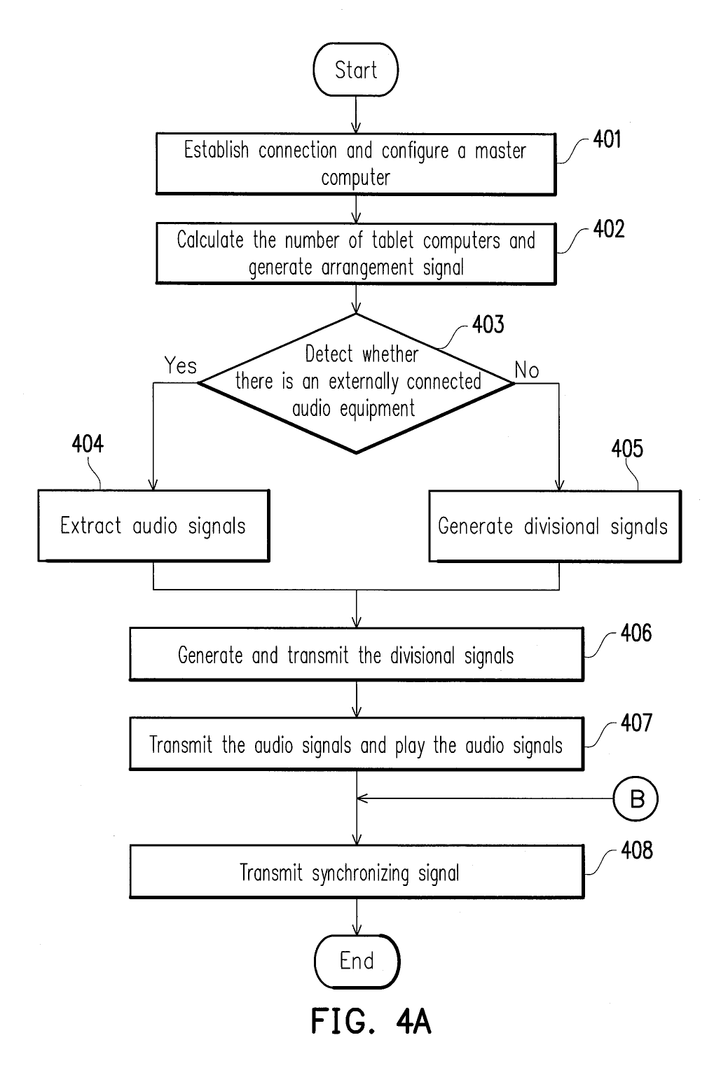

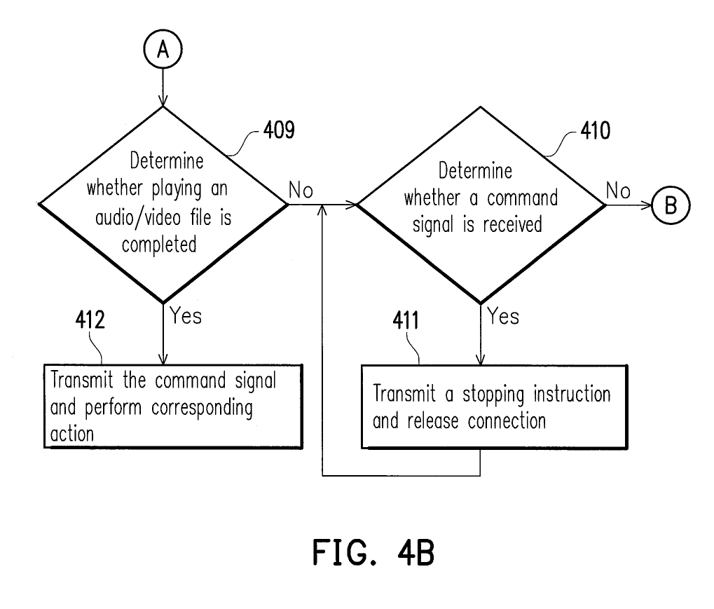

Additionally, it is noted that, in order to make the method for coordinating a tablet computer with at least one other tablet computer to play an audio/video file of the invention operate more quickly and fluently, in other preferred embodiments of the invention, the action of the master computer A detecting whether the master computer A or the slave computer B is connected to the audio equipment C may be omitted. That is, upon completing the step (402) in FIG. 4, the master computer A may directly execute the step (406); similarly, upon completing the step (502) in FIG. 5, the slave computer B may directly execute the step (505). As such, under certain circumstances (for example, the user had selected to use headsets, or the user would like to watch the audio/video file 240 in a muted situation), the tablet computers 2 may more quickly perform the action of playing the audio/video file 240, thereby enhancing fluency of operating the tablet computers 2.

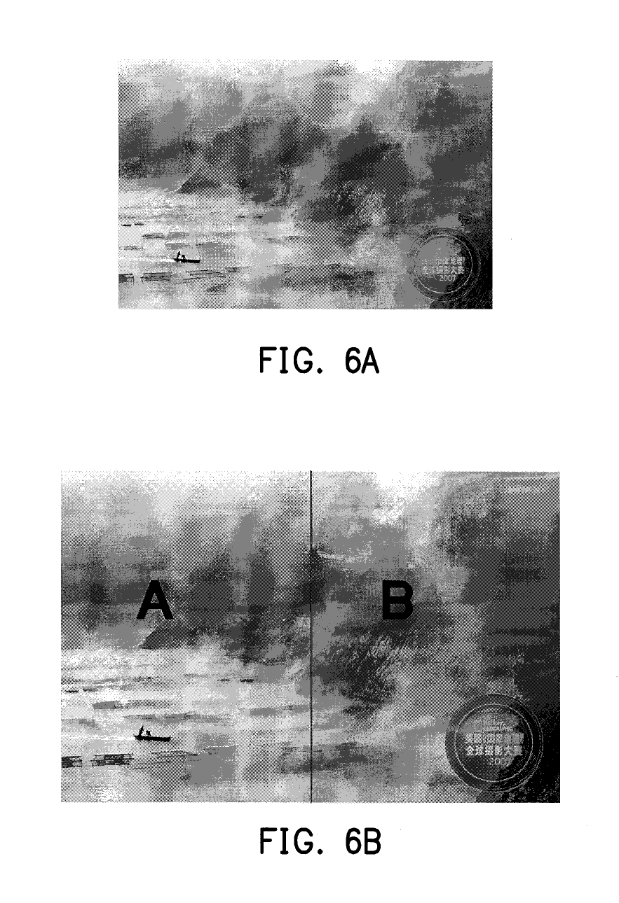

FIG. 6A is a schematic diagram of playing a video file by a single tablet computer. FIG. 6B is a schematic diagram of playing a video file by two tablet computers according to an embodiment of the invention. Referring to FIG. 6A, when there is only one tablet computer used to play the audio/video file, the display frame for playing of the audio/video file is limited by the display of the tablet computer. FIG. 6B illustrates the situation when there are two tablet computers arranged together. In FIG. 6B, A may refer to one divisional video frame displayed on a master computer A, and B may refer to other divisional video frame displayed on a slave computer B through the aforementioned method for coordinating a tablet computer with at least one other tablet computer to play an audio/video file of the invention. As a result, the overall display frame of the same audio/video file is doubled compared to the display frame of only one tablet computer. In fact, the implementation of the proposed method of the invention is not limited to merely two tablet computers being arranged together; and, in other embodiments, the number of tablet computers being arranged together may be more than two, and the resultant display frame of the same audio/video file may be increased by more than two times.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for coordinating a tablet computer with at least one other tablet computer to play an audio/video file, the method comprising the following steps:
establishing a wireless connection between a tablet computer acting as a master computer and at least one other tablet computer acting as a slave computer;
the master computer generating at least one arrangement signal according to the total number of the tablet computers that are connected and an arrangement of positions of the tablet computers, wherein the arrangement signal corresponds to an arranged position of the slave computer relative to the master computer;
the master computer generating at least two divisional signals according to the arrangement signal and an audio/video file, each corresponding to a portion of video frame in the audio/video file;
the master computer transmitting at least one of the divisional signals to the slave computer to enable the master computer and the slave computer to respectively display the portion of video frame corresponding to a respective one of the at least two divisional signals; and
the master computer transmitting a synchronizing signal to the slave computer to synchronize the displaying of the portion of video frame respectively by the master computer and the slave computer.

2. The method as claimed in claim 1, further comprising:
the master computer transmitting a stopping instruction to the slave computer to stop displaying the portion of video frame at the master computer and the slave computer.

3. The method as claimed in claim 1, wherein each of the tablet computers has an identifier establishing the identity of said each tablet computer for the step of establishing the wireless connection between the tablet computers.

4. The method as claimed in claim 1, further comprising:
the master computer receiving and then transmitting a command signal to the slave computer to enable each of the tablet computers to perform a corresponding action.

5. The method as claimed in claim 1, wherein upon the step of the master computer generating the arrangement signal, the method further comprising:
if the master computer or the slave computer is connected to an audio equipment, the master computer extracting an audio signal from the audio/video file, and transmitting the audio signal to the audio equipment for playing sounds of the video file by the audio equipment.

6. The method as claimed in claim 1, wherein upon the step of the master computer generating the arrangement signal, the method further comprising:
if the master computer or the slave computer is not connected to an audio equipment, the master computer generating a playing signal according to the arrangement signal and the audio/video file, and providing the playing signal for the master computer or the slave computer to play corresponding sounds of the audio/video file according to the playing signal.

7. A playing system for coordinating a tablet computer with at least one other tablet computer to play an audio/video file, the playing system comprising:
a tablet computer and at least one other tablet computer, each of the tablet computer and the other tablet computer having a display, a wireless transmission unit, and a control unit, wherein when the tablet computer and the other tablet computer are arranged with each other and connected by a wireless connection through their respective wireless transmission units, the tablet computer is configured to act as a master computer and the other tablet computer is configured to act as a slave computer, wherein:
the control unit of the master computer is configured to generate at least one arrangement signal according to the total number of the tablet computers that are connected and an arrangement of positions of the master and slave computers, wherein the arrangement signal corresponds to an arranged position of the slave computer relative to the master computer; to generate at least two divisional signals, according to the arrangement signal and an audio/video file, each corresponding to a portion of video frame in the audio/video file; and to transmit at least one of the divisional signals to the slave computer to enable the master computer and the slave computer to respectively display on their displays the portion of video frame corresponding to a respective one of the at least two divisional signals; and the control unit of the master computer is also configured to transmit a synchronizing signal to the slave computer to synchronize the displaying of the portion of video frame respectively by the master computer and the slave computer, and
the control unit of the slave computer is configured for displaying the portion of video frame corresponding to the transmitted at least one of the divisional signals and according to the received synchronizing signal.

8. The playing system as claimed in claim 7, wherein the control unit of the master computer is also configured to transmit a stopping instruction to the slave computer to stop displaying the portion of video frame at the master computer and the slave computer.

9. The playing system as claimed in claim 7, wherein each of the tablet computer and the at least one other tablet computer has an identifier establishing the identity of said each tablet computer in establishing the wireless connection between the tablet computers.

10. The playing system as claimed in claim 7, wherein the master computer is configured to receive and then transmit a command signal to the slave computer to enable each of the tablet computers to perform a corresponding action.

11. The playing system as claimed in claim 7, wherein if the master computer or the slave computer is connected to an audio equipment, the master computer is configured to extract an audio signal from the audio/video file and transmit the audio signal to the audio equipment for playing sounds of the video file by the audio equipment.

12. The playing system as claimed in claim 7, wherein if the master computer or the slave computer is not connected to an audio equipment, the master computer is configured to generate a playing signal according to the arrangement signal and the audio/video file, and provide the playing signal for the master computer or the slave computer to play corresponding sounds of the video file according to the playing signal.
